(19) United States
(12) Patent Application Publication
(10) Pub. No.: US 2021/0082428 A1
(43) Pub. Date: Mar. 18, 2021

(54) INFORMATION PROCESSING SYSTEM, CLIENT DEVICE, INFORMATION PROCESSING METHOD, AND INFORMATION PROCESSING PROGRAM

(71) Applicant: SONY CORPORATION, TOKYO (JP)

(72) Inventors: YUJI NASHIMAKI, TOKYO (JP); HISAHIRO SUGANUMA, TOKYO (JP); DAISUKE FUKUNAGA, TOKYO (JP)

(21) Appl. No.: 17/046,300

(22) PCT Filed: Feb. 25, 2019
(86) PCT No.: PCT/JP2019/006938

§ 371 Date: Oct. 8, 2020

(30) Foreign Application Priority Data
Apr. 17, 2018 (JP) 2018-078850

(51) Int. Cl. G10L 15/22; G06F 3/16; G06F 21/31

(52) U.S. Cl. CPC G10L 15/22; G10L 2015/223; G06F 21/31; G06F 3/167

(57) ABSTRACT

Included are a client device configured to transmit, based on a voice of a user input from a voice input unit, voice information to an information processing server, and execute, based on response information received in response to the voice information, a sequence of providing a response for the user; and an information processing server configured to generate response information based on the received voice information, and transmit the response information to the client device. A plurality of sequences, each being the sequence, can be executed in one connection established between the client device and the information processing server.

### TECHNICAL FIELD

The present disclosure relates to an information processing system, a client device, an information processing method, and an information processing program.

### BACKGROUND ART

Opportunities to use various information processing devices in daily life and business are increasing nowadays. Keyboards and mice in personal computers have been mostly used for inputs and commands to information processing devices. At the present time, with the improvement of the accuracy of voice recognition, it is possible for a smart speaker (also called an AI speaker) and the like to receive voice inputs and voice commands. Such an information processing device is generally connected to an information processing server and used as a client device of the information processing server device.

PTL 1 discloses a system device capable of returning, when transaction information including voice is transmitted from a terminal to a service center, a voice guidance from the service center.

### CITATION LIST

### Patent Literature

### [PTL 1]

### JP 3293790B

### SUMMARY

### Technical Problem

In such fields, it is desired to improve the response in a dialogue between a user and a client device.

An object of the present disclosure is to provide an information processing system, a client device, an information processing method, and an information processing program configured to reduce the response time in a dialogue between a user and a client device.

### Solution to Problem

The present disclosure is, for example, an information processing system including: a client device configured to transmit, based on a voice of a user input from a voice input unit, voice information to an information processing server, and execute, based on response information received in response to the voice information, a sequence of providing a response for the user; and an information processing server configured to generate response information based on the received voice information, and transmit the response information to the client device, wherein the information processing system is configured to enable a plurality of sequences, each being the sequence, to be executed in one connection established between the client device and the information processing server.

The present disclosure is, for example, a client device configured to transmit, based on a voice of a user input from a voice input unit, voice information to an information processing server, and execute, based on response information received in response to the voice information, a sequence of providing a response for the user, wherein the client device is configured to enable a plurality of sequences, each being the sequence, to be executed in one connection established with the information processing server.

The present disclosure is, for example, an information processing method includes transmitting, based on a voice of a user input from a voice input unit, voice information to an information processing server, and executing, based on response information received in response to the voice information, a sequence of providing a response for the user, and enabling a plurality of sequences, each being the sequence, to be executed in one connection established with the information processing server.

The present disclosure is, for example, an information processing program configured to transmit, based on a voice of a user input from a voice input unit, voice information to an information processing server, and execute, based on response information received in response to the voice information, a sequence of providing a response for the user, and enable a plurality of sequences, each being the sequence, to be executed in one connection established with the information processing server.

### Advantageous Effects of Invention

According to at least one embodiment of the present disclosure, it is possible to reduce the response time in a dialogue between the user and the client device. The advantageous effect described here is not necessarily limited, and any advantageous effects described in the present disclosure may be enjoyed. Further, the content of the present disclosure should not be limitedly interpreted by the exemplified advantageous effects.

### BRIEF DESCRIPTION OF DRAWINGS

FIG. 1 is a diagram illustrating a configuration of an information processing system according to an embodiment.

FIG. 2 is a block diagram illustrating a configuration of a smart speaker according to the embodiment.

FIG. 3 is a diagram illustrating an operation example of the information processing system according to the embodiment.

FIG. 4 is a diagram illustrating data structures of various pieces of information according to the embodiment.

FIG. 5 is a flowchart illustrating processing of the smart speaker according to the embodiment.

FIG. 6 is a diagram illustrating the configuration of an information processing system according to an embodiment.

FIG. 7 is a diagram illustrating an operation example of the information processing system according to the embodiment.

FIG. 8 is a flowchart illustrating processing of a smart speaker according to the embodiment.

FIG. 9 is a diagram illustrating a configuration of an information processing system according to an embodiment.

### DESCRIPTION OF EMBODIMENTS

Hereinafter, embodiments of the present disclosure and others will be described with reference to the drawings. Note that the description will be given in the following order.

### <1. First Embodiment>

### <2. Second Embodiment>

### <3. Modified Examples>

Embodiments and others described below are preferred specific examples of the present disclosure, and the content of the present disclosure is not limited to the embodiments and the others.

### 1. First Embodiment

### (Configuration of Information Processing System)

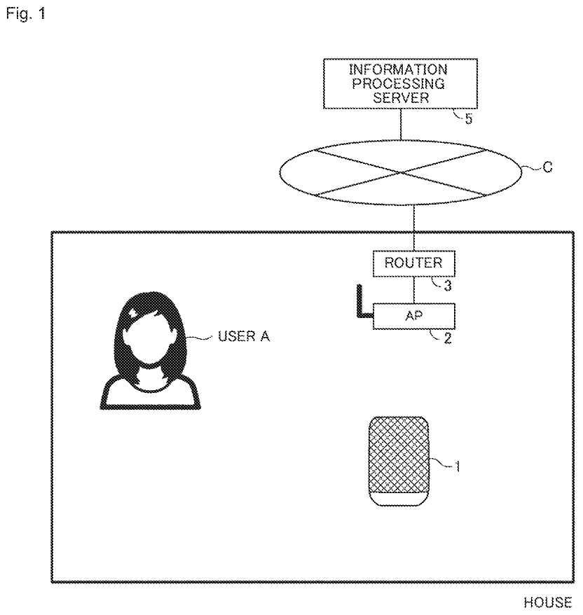

FIG. 1 is a diagram illustrating a configuration of an information processing system according to a first embodiment. The information processing system according to the first embodiment is configured to include a smart speaker 1 serving as a client device and an information processing server 5 communicatively connected to the smart speaker 1. The smart speaker 1 and the information processing server 5 are communicatively connected via a communication network C such as the internet line. Further, an access point 2 and a router 3 for communicatively connecting the smart speaker 1 to the communication network C are installed in a house. The smart speaker can be communicatively connected to the communication network C via the access point 2 wirelessly connected to the smart speaker 1 and the router 3 to communicate with the information processing server 5.

The smart speaker 1 is a device capable of performing various processing based on a voice input from a user A, and has, for example, a dialogue function of replying to a voice inquiry of the user A by voice. In this dialogue function, the smart speaker 1 converts the input voice into voice data and transmits the voice data to the information processing server 5. The information processing server 5 performs voice recognition on the received voice data, generates a response to the voice data as text data, and returns the text data to the smart speaker 1. The smart speaker 1 can perform voice synthesis based on the received text data to transmit a voice response to the user A. In the present embodiment, an example is described in which such a function is applied to the smart speaker, but the function is not limited for smart speakers, and is available on various products, for example, home electric appliances such as TV sets, or car navigation systems.

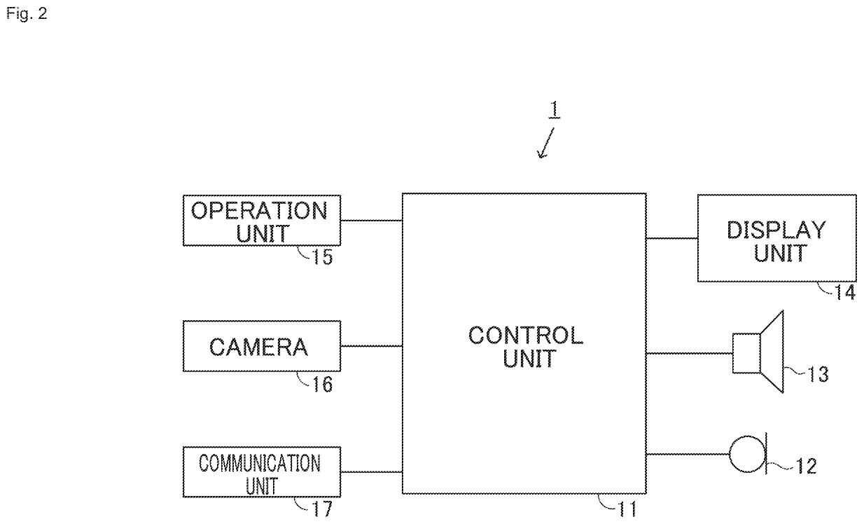

FIG. 2 is a block diagram illustrating a configuration of the smart speaker 1 according to the first embodiment. The smart speaker 1 according to the first embodiment includes a control unit 11, a microphone 12, a speaker 13, a display unit 14, an operation unit 15, a camera 16, and a communication unit 17.

The control unit 11 is configured to include a CPU (Central Processing Unit) capable of executing various programs, a ROM configured to store various programs and data, a RAM, and the like, and is a unit for integrally controlling the smart speaker 1. The microphone 12 corresponds to a voice input unit capable of collecting ambient sounds, and collects a voice uttered by the user in the dialogue function. The speaker 13 is a unit for transmitting various kinds of information acoustically to the user. The dialogue function can provide various notifications by voice to the user by emitting a voice generated based on the text data.

The display unit 14 is configured by using liquid crystal, organic EL (Electro Luminescence), or the like, and is a unit capable of displaying various pieces of information such as the state of the smart speaker 1 and time. The operation unit 15 is a unit, such as a power button and volume buttons, for receiving an operation from the user. The camera 16 is a unit capable of capturing an image around the smart speaker 1 to acquire a still image or a moving image. Note that a plurality of cameras 16 may be provided so that the all images around the smart speaker 1 can be captured.

The communication unit 17 is a unit for communicating with various external devices. In the present embodiment, the communication unit 17 communicates with the access point 2, and thus is in a form using the Wi-Fi standard. In addition to this, as the communication unit 17, a means of short-range communication such as infrared communication may be used, or a means of mobile communication may be used that can be connected to the communication network C via a mobile communication network instead of the access point 4.

### (Operation Example of Information Processing System)

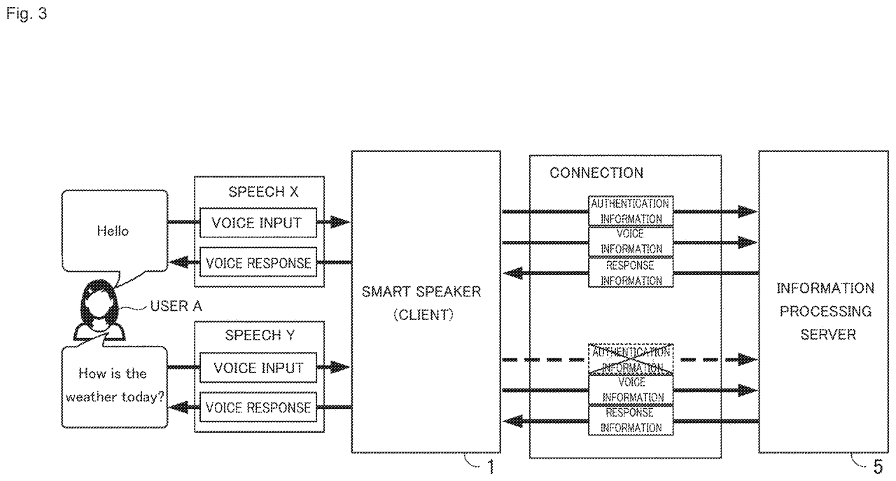

FIG. 3 is a diagram for explaining an operation example of the information processing system according to the first embodiment, that is, an example of operations between the user A, the smart speaker 1, and the information processing server 5. Here, the dialogue function using the smart speaker 1 will be described. As illustrated in FIG. 3, the user A speaks to the smart speaker 1 so that the user A can receive a voice response from the smart speaker 1. For example, when the user A says “Hello” as a speech X to the smart speaker 1, the smart speaker 1 can return a voice response of “How are you?” (not illustrated).

Further, when the user A says, “How is the weather today?” as a speech Y to the smart speaker 1 after the voice response to the speech X is completed, the smart speaker 1 can return a voice response of “The weather is sunny today” (not illustrated).

Such voice responses to the speeches X and Y are not obtained by the smart speaker 1 alone, but are obtained by voice recognition in the information processing server 5 and by using various databases. Therefore, the smart speaker 1 communicates with the information processing server 5 by the communication scheme described with FIG. 1.

In a conventional dialogue function like this, a connection is established between the smart speaker 1 and the information processing server 5 each time a dialogue is performed. In the case of FIG. 3, a connection is established twice between the smart speaker 1 and the information processing server 5 for each of the speeches X and Y. In the case where a connection is established on a speech basis, the overhead associated with processing of establishing the connection increases, which can be disadvantageous due to the increase of the response time by a voice response in a dialogue. Further, at the time of establishing a connection, authentication processing is usually performed between the smart speaker 1 and the information processing server 5. Accordingly, the overhead will include the authentication processing, and it is expected that the overhead can be more disadvantageous due to the further increase of the response time by the voice response in the dialogue.

The present disclosure has been made in view of such a situation, and describes one feature that a plurality of sequences can be executed in one connection established between the smart speaker 1 and the information processing server 5.

Communications between the smart speaker 1 and the information processing server 5, which corresponds to the feature, will be described with reference to FIG. 3.

In the present embodiment, a connection between the smart speaker 1 and the information processing server 5 is started on the condition that the user A says something, that is, a voice is input. In the present embodiment, the information processing server 5 needs authentication processing for the smart speaker 1 when starting the connection. Accordingly, the smart speaker 1 first transmits authentication information necessary for the authentication processing to the information processing server 5.

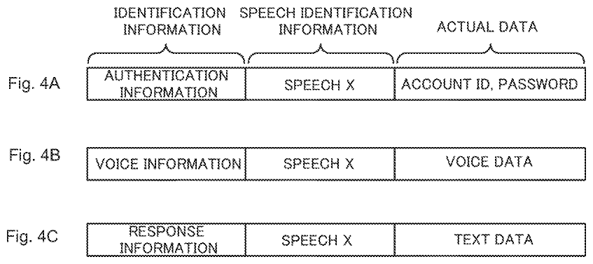

FIG. 4 illustrates data structures of various pieces of information according to the embodiment. FIG. 4(A) is a diagram illustrating a data structure of the authentication information. The authentication information includes identification information, speech identification information, and actual data. The identification information is information indicating that the information is authentication information. The speech identification information is identification information assigned to each speech, and for the speech X in FIG. 3, the speech identification information is assigned so that the speech X can be identified. The actual data in the authentication information corresponds to, for example, an account ID, a password, and the like of the smart speaker 1.

The information processing server 5, when receiving the authentication information, refers to the account ID and password included in the authentication information on the database to determine whether authentication is successful or not. Note that whether the authentication is successful or not may be performed by an authentication server (not illustrated) provided separately from the information processing server 5. When the authentication is successful, the information processing server 5 generates response information based on the voice information received almost simultaneously with the authentication information.

FIG. 4(B) is a diagram illustrating a data structure of the voice information. The voice information includes identification information, speech identification information, and actual data, as with the authentication information. The identification information is information indicating that the information is voice information. The speech identification information is identification information assigned to each speech, and for the speech X in FIG. 3, the speech identification information is assigned so that the speech X can be identified. The actual data in the authentication information is voice data input to the microphone 12 of the smart speaker 1, and for the speech X, the actual data corresponds to a user A's voice of “Hello”.

The information processing server 5 performs voice recognition processing on the voice data in the received voice information to convert it into text information. Then, based on the resulting text information, response information is generated, for example, by referring to various databases, and the response information is returned to the smart speaker 1 which has transmitted the voice information. FIG. 4(C) is a diagram illustrating a data structure of the response information transmitted from the information processing server 5. The response information includes identification information, speech identification information, and actual data, as with the authentication information or the like. The identification information is information indicating that the information is response information. The speech identification information is identification information assigned to each speech, and for the speech X in FIG. 3, the speech identification information is assigned so that the speech X can be identified. The actual data in the response information is text data of contents for the speech X “Hello”, and corresponds to, for example, the text data of the content “How are you?”.

The smart speaker 1 provides a voice response for the user A by voice synthesis of the text data included in the received response information. This completes the dialogue corresponding to the speech X. A conventional connection between the smart speaker 1 and the information processing server 5 is disconnected in response to the completion of the dialogue. Accordingly, when the dialogue corresponding to the next speech Y is started, the authentication information is transmitted again so that a connection is established.

In the information processing system according to the present disclosure, the connection is maintained even when the dialogue corresponding to the speech X is completed, and preparation is made for the next speech Y. When the next speech Y by the user A is input by voice, the smart speaker 1 transmits voice information including the speech Y, for example, the voice data of “How is the weather today?” in FIG. 3, to the information processing server 5. In this case, since the authentication processing has already been completed in the first sequence for the speech X, the authentication information is not transmitted in the second and subsequent sequences in the same connection. In this way, in the present embodiment, the sequences of the same connection for the same user are performed so that the processing step number in each sequence after the first sequence is smaller than the processing step number in the first sequence. Therefore, it is possible to reduce the overhead in the sequences (corresponding to the speech Y in the example of FIG. 3) after the first sequence and reduce the response time of the voice response.

The information processing server 5, when receiving the voice information corresponding to the speech Y, generates response information based on the received voice information, and transmits the response information to the smart speaker 1. The response information includes, for example, text data of the content “The weather is sunny today”. The smart speaker 1 performs voice synthesis on the text data to provide a voice response for the user A, and the dialogue corresponding to the speech Y is completed. Note that the connection between the smart speaker 1 and the information processing server 5 will be disconnected when a disconnection condition is satisfied. The disconnection condition will be described below in detail.

### (Processing of Smart Speaker 1)

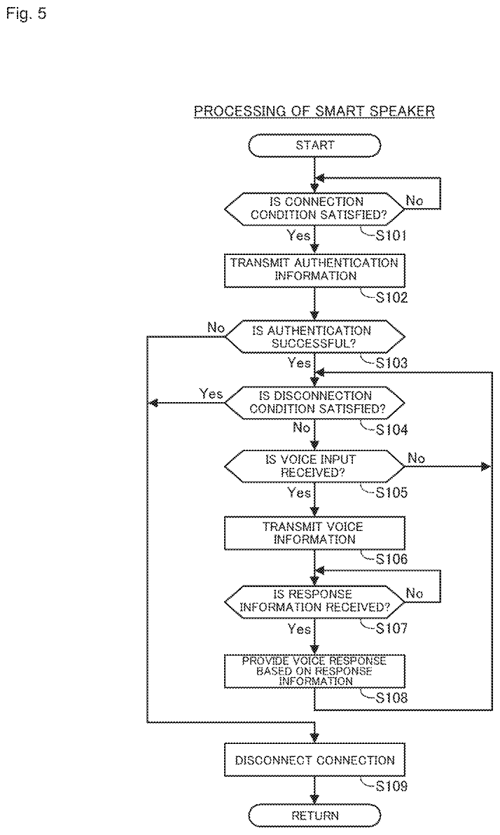

FIG. 5 is a flowchart illustrating processing of the smart speaker 1 according to the embodiment, and is a flowchart illustrating the processing of the smart speaker 1 described with FIG. 3. At the start of the processing, the smart speaker 1 is in a state where no connection with the information processing server 5 is established. When a connection condition is satisfied (S101: Yes), the smart speaker 1 transmits the authentication information to the information processing server 5 to start to establish a connection (S102). In the case of FIG. 3, the connection condition to be used is a voice input from the user being detected.

When the authentication is successful on the information processing server 5 (S103: Yes), the smart speaker 1 transmits the voice information to the information processing server 5 (S106). On the other hand, when the authentication is not successful, the connection is disconnected (S109), and the processing returns to the detection, which is the connection condition (S101). At that time, the smart speaker 1 may notify the user of a message such as “Authentication unsuccessful” by emitting it by voice from the speaker 13 or displaying it on the display unit 14. On the other hand, when the authentication is successful on the information processing server 5 (S103: Yes), the smart speaker 1 starts to monitor the disconnection condition (S104).

When the disconnection condition is not satisfied (S104: No), it is determined whether or not a voice is input (S105). In the present embodiment, since the connection condition is a voice input being received, it is determined that the voice is input (S105: Yes), and the voice information is transmitted to the information processing server 5 (S106). After that, the smart speaker 1 waits to receive response information for the voice information from the information processing server 5 (S107: No), and the smart speaker 1, when receiving the response information (S107: Yes), performs voice synthesis based on the text data included in the response information to provide a voice response (S108).

In the present embodiment, the step of processing for transmitting the voice information to the information processing server 5 to the step of processing for providing a voice response based on the response information received from the information processing server 5, that is, the steps of processing after the user inputs a voice until a response to the voice input is obtained correspond to one sequence. When the voice response based on the response information is completed, that is, when one sequence is completed, the smart speaker 1 starts to monitor the disconnection condition (S104) and monitor the voice input (S105). When the disconnection condition is not satisfied during monitoring (S104: No), the sequence is repeatedly performed. On the other hand, when the disconnection condition is satisfied (S104: Yes), the smart speaker 1 disconnects the connection with the information processing server 5 (S109), and the processing returns to the detection, which is the connection condition (S101).

As described above, in the information processing system according to the present embodiment, it is possible to execute a plurality of sequences in one connection. Therefore, it is possible to reduce the response time of the voice response without the overhead such as the authentication processing for each sequence.

In the flowchart of FIG. 5, various modes can be adopted as the connection condition for the connection to be used in S101. Properly setting the connection condition makes it possible to reduce the waste of keeping the connection open and reduce the delay of the voice response when establishing the initial connection. Various modes of connection conditions will be described below. Note that these connection conditions can be used not only alone but also in combination.

### (First Connection Condition)

A first connection condition is a method using the condition that the smart speaker 1 receives a voice input. The first connection condition is the connection condition described with FIG. 3, so that the smart speaker 1 with which no connection is established starts a connection with the information processing server 5 in response to detecting a voice input. Using the first connection condition makes it possible to reduce the waste of keeping the connection open.

### (Second Connection Condition)

A second connection condition is a method using various sensors mounted on the smart speaker 1 to detect a situation that requires a connection with the information processing server 5. For example, when the camera 16 mounted on the smart speaker 1 is used to capture an image of the surroundings and detects the user being in the surroundings, a connection is established. Such a mode can establish a connection in advance before the user says something, so that it is possible to reduce the response time of a voice response. Note that when the camera 16 is used, the line of sight of the user may be used. Before the user speaks to the smart speaker 1, it is expected that user looks at the smart speaker 1. A connection may be established on a condition that the camera 16 detects the line of sight to the smart speaker.

Further, not only the camera 16 but also the microphone 12 may detect footsteps and the like to determine whether the user is in the surroundings or approaching, so that a connection is established. In such a mode, a vibration sensor may be used instead of the microphone 12.

### (Third Connection Condition)

A third connection condition is a method of estimating a user's activity to detect a situation that requires a connection with the information processing server 5. For example, the smart speaker 1 can have a schedule management function. For example, a wake-up time described in a schedule of the user used in the schedule management function can be used to establish a connection before the wake-up time. After waking up, the user can obtain weather information, traffic information, news, and others by voice response using the smart speaker 1 with which the connection has already been established. Note that the user's activity can be estimated not only by the schedule management function but also by acquiring the location and behavior of the user from a mobile terminal possessed by the user.

In the flowchart of FIG. 5, various modes can also be adopted as the disconnection condition for the connection to be used in S104. Properly setting the disconnection condition makes it possible to suppress the waste of keeping the connection open. Various modes of disconnection conditions will be described below. Note that these disconnection conditions can be used not only alone but also in combination.

### (First Disconnection Condition)

A first disconnection condition is a method of disconnecting the connection according to a time duration during which the connection is not in use. For example, when the connection is not in use for a predetermined time (e.g., 10 minutes), that is, when the sequence is not performed, the connection can be disconnected.

### (Second Disconnection Condition)

A second disconnection condition is a method of disconnecting the connection on a condition that the sequence has been performed a predetermined number of times. For example, the connection can be disconnected on a condition that a voice input is received from the user a predetermined number of times (e.g., 10 times) and response information for each voice input is received.

### (Third Disconnection Condition)

A third disconnection condition is a method of detecting an incorrect sequence to disconnect the connection. For example, it is a method of disconnecting the connection when it is detected that the response information does not comply with a predetermined data structure, or the order of transmitting or receiving various pieces of information is not a prescribed order. Using the third disconnection condition makes it possible not only to reduce the waste of keeping the connection open but also to prevent unauthorized access.

### (Fourth Disconnection Condition)

A fourth disconnection condition is a method of disconnecting the connection based on the context in a dialog with the user. For example, it is a method of disconnecting the connection when a voice input for ending a dialog between the user and the smart speaker 1, such as “That's all” or “Bye”, is detected in the dialog. Note that, even if there is no word for explicitly ending the dialogue, it can be a method of disconnecting the connection when it is presumed that the dialogue is likely to end in terms of the flow of the dialogue.

### (Fifth Disconnection Condition)

A fifth disconnection condition is a method of disconnecting the connection when it is determined using the various sensors of the smart speaker 1 that no connection with the information processing server 5 is necessary. For example, the connection can be disconnected when it is detected from the image of the camera 16 that there is no person in the surroundings, or when there is no person in the surroundings for a certain period of time. Note that the sensor is not limited to the camera 16, and the microphone 12 or a vibration sensor or the like may be used to detect the presence or absence of a person in the surroundings.

### 2. Second Embodiment

### (Operation Example of Information Processing System)

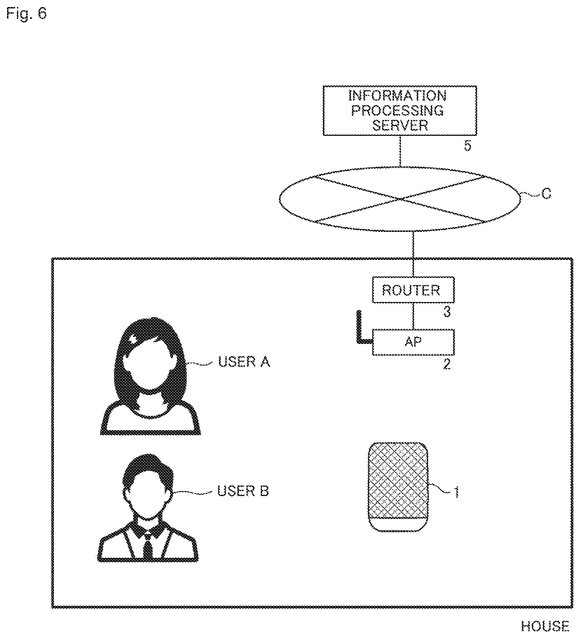

FIG. 6 is a diagram illustrating a configuration of an information processing system according to a second embodiment. The second embodiment does not differ greatly from the first embodiment in the information processing system, and the smart speaker 1, the information processing server 5, and the communication configuration between them are substantially the same. Therefore, the description of each device is omitted here. The second embodiment is different from the first embodiment in which the smart speaker 1 is authenticated in the authentication processing in that the user is authenticated. Accordingly, as illustrated in FIG. 6, in a case where one smart speaker 1 is shared among a user A and a user B, it is necessary to authenticate each user.

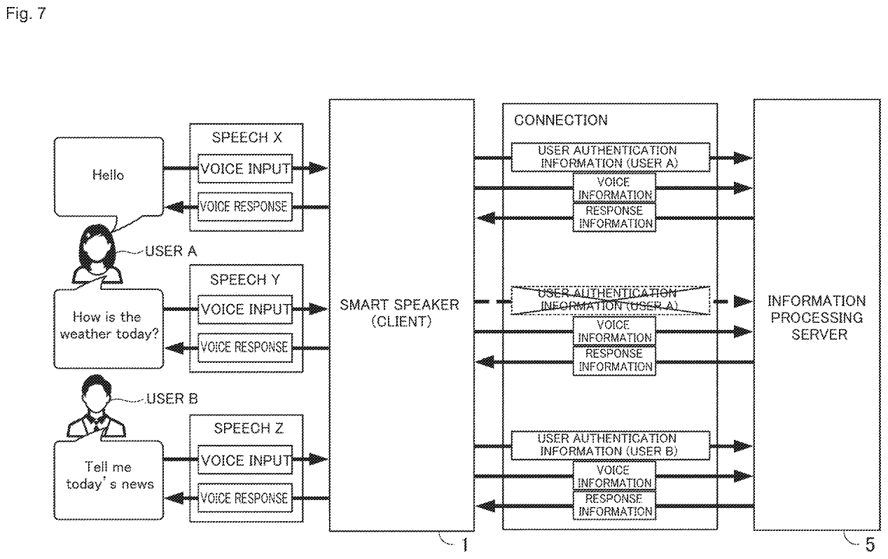

FIG. 7 is a diagram for explaining an operation example of the information processing system according to the second embodiment, that is, an example of operations between the user A, the user B, the smart speaker 1, and the information processing server 5. This operation example is for a case where the user A makes a speech X and a speech Y, and then the user B makes a speech Z.

Also in the second embodiment, the connection condition to be used is a user's voice input being detected, and a connection is started in response to the user's voice input in a state in which no connection with the smart speaker 1 is established. When the user A says “Hello” as the speech X to the smart speaker 1, the smart speaker 1 transmits user authentication information of the user A to the information processing server. Here, as the user authentication information, an account ID, a password, and the like are used that is stored for a recognized user who has been recognized based on an input voice by using a technique such as speaker recognition in the smart speaker 1. Note that such user authentication information is not limited to such a form, and various forms can be adopted such as that obtained by transmitting voice data of the user and performing speaker recognition at the information processing server 5 end.

When the authentication processing is completed, the smart speaker 1 transmits the voice information to the information processing server 5, and waits to receive response information. The smart speaker 1, when receiving the response information, performs voice synthesis based on the text information included in the response information, and thus provides a voice response whose content is, for example, “How are you?”.

Next, when the user A says, “How is the weather today?” as the speech Y to the smart speaker 1, the smart speaker 1 does not transmit the user authentication information of the user A because the authentication processing for the user A has been completed in the connection being established. In this case, the smart speaker 1 performs speaker recognition based on the input voice of the speech Y, and identifies the user A. If the user A is a user who has already been authenticated in the connection, the smart speaker 1 does not transmit the user authentication information. Note that, for home use and the like, the number of users who use the smart speaker 1 is often limited, and therefore, it is possible to identify the user even by speaker recognition with low accuracy.

Accordingly, when the speech Y is input by voice, the smart speaker 1 transmits the voice information without transmitting the user authentication information and waits for response information. The smart speaker 1, when receiving the response information, performs voice synthesis based on the text information included in the response information, and thus provides a voice response whose content is, for example, “The weather is sunny today”.

Next, when the user B says “Tell me today's news” as the speech Z to the smart speaker 1, the smart speaker 1 identifies the user based on the input voice. Since the user B identified from the speech Z is not a user who has been authenticated in the connection, user authentication information related to the user B is transmitted to the information processing server 5, and when authentication is completed, the voice information is transmitted to the information processing server 5. Then, based on response information received from the information processing server 5, a voice response such as news reading is provided.

Also in the second embodiment, the connection between the smart speaker 1 and the information processing server 5 is continuously established until the disconnection condition is satisfied. As described above, also in the second embodiment, it is possible to execute a plurality of sequences in one connection. Therefore, it is possible to reduce the response time of the voice response without the overhead for establishing the connection for each sequence. Further, when the same user says something again in the connection, the user authentication is not performed again, so that it is possible to reduce the response time of the voice response.

### (Processing of Smart Speaker 1)

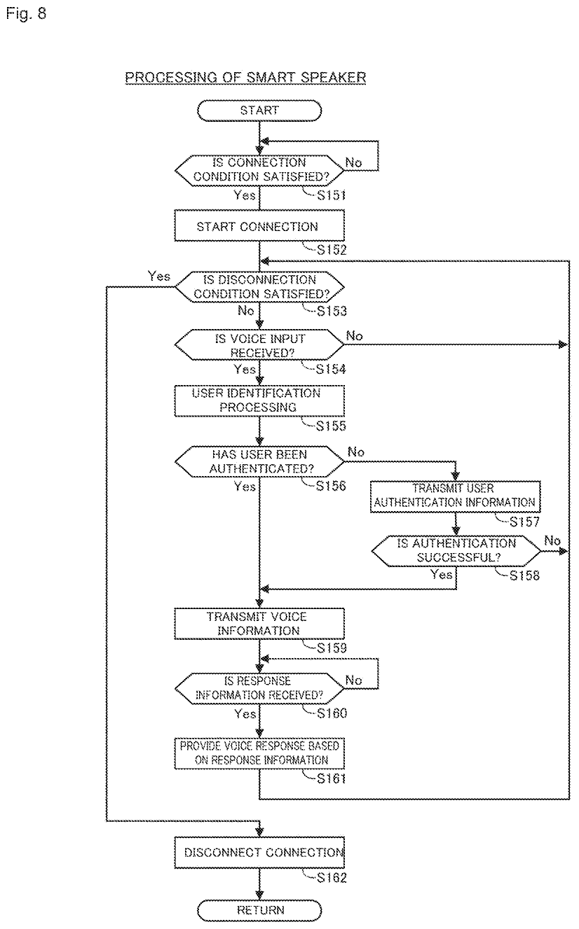

FIG. 8 is a flowchart illustrating processing of the smart speaker 1 according to the embodiment, and is a flowchart illustrating the processing of the smart speaker 1 described with FIG. 7. At the start of the processing, the smart speaker 1 is in a state where no connection with the information processing server 5 is established. When the connection condition is satisfied (S151: Yes), the smart speaker 1 starts a connection to the information processing server 5 (S152). Also in the second embodiment, as in the first embodiment, the connection condition to be used is a user's voice input being detected.

Then, the smart speaker 1 starts to monitor the disconnection condition (S153) and monitor a voice input (S154). Then, when a voice is input (S154: Yes), user identification processing (S155) is performed based on the input voice. Note that, in the present embodiment, since a user's voice input being detected is used as the connection condition, at the start of the connection, it is determined that the voice input is received (S154: Yes), and the user identification processing (S155) is performed.

In the user identification processing (S155), user identification is performed using speaker recognition or the like, and it is determined whether or not the user has already been authenticated in the connection (S156). If the user has not already authenticated (S156: No), the smart speaker 1 transmits the user authentication information to the information processing server 5. In the example of FIG. 7, the first speech X of the user A and the first speech Z of the user B correspond to those to be processed.

The information processing server 5 performs the authentication processing based on the received user authentication information, and transmits the authentication result to the smart speaker 1. When the authentication is successful (S158: Yes), the smart speaker 1 transmits the voice information to the information processing server 5 (S159). On the other hand, when the authentication is not successful (S158: No), the processing returns to S153 to start to monitor the disconnection condition (S153) and monitor a voice input (S154). At that time, the smart speaker 1 may notify the user of a message such as “Authentication unsuccessful” by emitting it by voice from the speaker 13 or displaying it on the display unit 14.

After that, the smart speaker 1 waits to receive response information for the voice information from the information processing server 5 (S160: No), and the smart speaker 1, when receiving the response information (S160: Yes), performs voice synthesis based on the text data included in the response information to provide a voice response (S161).

On the other hand, when the disconnection condition is satisfied (S153: Yes) during the monitoring of the disconnection condition (S153) and the monitoring of a voice input (S154), the smart speaker 1 disconnects the connection with the information processing server 5 (S162), and the processing returns to the detection, which is the connection condition (S151).

Also in the present embodiment, the steps of processing after the user inputs a voice until a response to the voice input is obtained are defined as one sequence, and a plurality of sequences can be executed in one connection. Therefore, it is possible to reduce the response time of the voice response without the overhead such as the user authentication processing for each sequence. Note that the various modes described in the first embodiment or a combination thereof can be adopted as the connection condition and the disconnection condition for the connection in the second embodiment.

### 3. MODIFIED EXAMPLES

### First Modified Example

In the first and second embodiments described above, the smart speaker 1 is adopted as a client device, but the client device may be any device as long as it supports voice input, and various forms can be adopted. Further, the response of the client device based on the response information received from the information processing server 5 is not limited to a voice response, and may be a response such as a display on the display unit of the smart speaker 1, for example.

### Second Modified Example

In the first and second embodiments described above, the voice information transmitted from the smart speaker 1 includes the voice data of the user, and the voice recognition is performed at the information processing server 5 end. Instead of such a form, the voice recognition may be performed at the smart speaker 1 end. In that case, the voice information transmitted from the smart speaker 1 to the information processing server 5 includes text information and the like as a result of voice recognition.

### Third Modified Example

In the above-described first and second embodiments, the number of sequences in one connection is not limited. In such a case, there is a possibility that the load on the information processing server 5 or the like increases, thereby reducing the response performance of the one sequence. Therefore, the number of sequences in one connection may be limited. For example, the number of allowable sequences can be set as a threshold value, and when the threshold value is exceeded, a new connection can be established so as to process the sequences across a plurality of connections. Such a method makes it possible to distribute the load on the connection and stabilize the response of the sequence.

### Fourth Modified Example

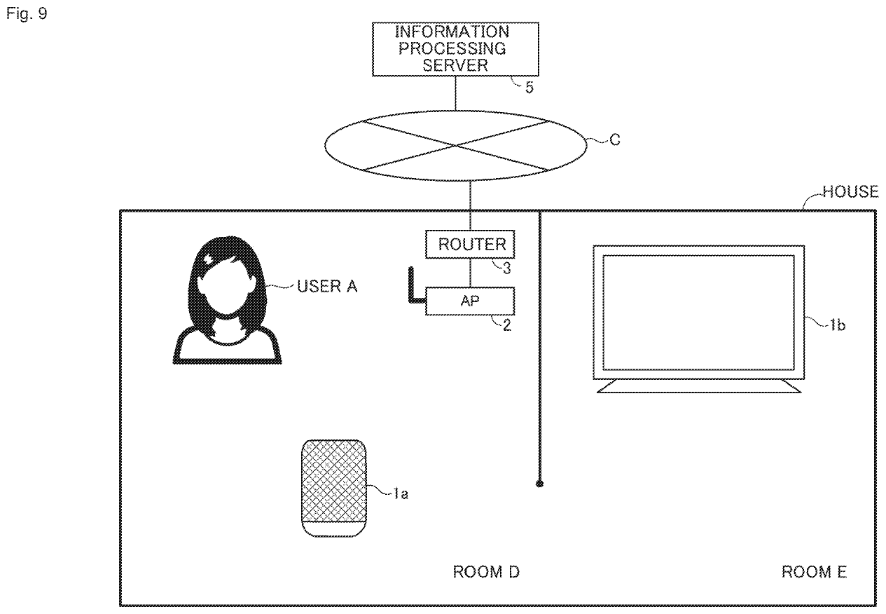

As interactive devices (client devices) such as the smart speaker 1 become widespread in the future, it is expected that a plurality of interactive devices will be installed in a house. FIG. 9 is a diagram illustrating a configuration of an information processing system according to a fourth modified example. In FIG. 9, a smart speaker 1a serving as a client device is installed in a room D, and a smart TV set 1b serving as a client device is installed in a room E. Both are interactive devices capable of supporting a user's voice input. Further, both the smart speaker 1a and the smart TV set 1b are wirelessly connected at the access point 2 to communicate with each other.

Using such a configuration of the information processing system makes it possible for the information processing server 5 to reduce the number of connections. For example, assume that the smart TV set 1b installed in the room E has already established a connection, and the connection to the smart speaker 1a installed in the room D is disconnected. In this state, when the user A says something to the smart speaker 1a in the room D, the smart speaker 1a searches for a client device that has already established a connection in the house. In this case, it is detected that the smart TV set 1b has already established a connection. The smart speaker 1a transfers various information to the smart television 1b without newly establishing a connection with the information processing server 5, and executes the sequence using the connection of the smart television 1b. The response information received in the sequence is transferred from the smart TV set 1b to the smart speaker 1a, and the smart speaker 1a provides a voice response.

In this way, the fourth modified example makes it possible to use, in a situation where a plurality of interactive devices (client devices) are installed, an already established connection to avoid adding a new connection, thereby reducing the load on the information processing server 5. In addition, it is possible to reduce the overhead due to the establishment of a new connection and also reduce the response time of voice response. Note that, in the fourth modified example, the number (maximum number) of connections that can be established in the house may be any number such as one or multiple.

### Fifth Modified Example

Although the first to fifth disconnection conditions are described in the first embodiment, a sixth disconnection condition described below can be used as the disconnection condition for the configuration of the information processing system described with FIG. 9. The sixth disconnection condition is a method using the usage status of a plurality of interactive devices (client devices) to disconnect the connection. Specifically, it is a method of checking the number of users for which the interactive devices are available, and disconnecting the connection when an interactive device is apparently impossible to use. Therefore, as described in the second embodiment, each interactive device needs to perform user authentication.

In FIG. 9, for example, assume that only the user A is registered in the smart speaker 1a and the smart TV set 1b. For example, consider a situation in which the user A engages in a dialogue with the smart speaker 1a in the room D, then moves to the room E to engage in a dialogue with the smart TV set 1b. When the user A has engaged in a dialogue with the smart TV set 1b, it is determined that only the smart TV set 1b that is currently engaged in the dialogue is used, and the connection of the smart speaker 1a is disconnected. In this way, in a situation where a plurality of interactive devices are available, it is possible to reduce the load on the information processing server 5 by deleting unnecessary connections based on the user registration status and usage status.

The present disclosure can also be implemented by an apparatus, a method, a program, a system or the like. For example, a program that performs the functions described in the above-mentioned embodiments can be downloaded, so that a device that does not have the functions described in the embodiments can download the program to perform the control described in the embodiments in that device. The present disclosure can also be implemented by a server configured to distribute such a program. Further, the matters described in each of the embodiments and the modified examples can be combined as appropriate.

The present disclosure may also be configured as follows.

(1)

An information processing system including:

a client device configured to transmit, based on a voice of a user, the voice being input from a voice input unit, voice information to an information processing server, and execute, based on response information received in response to the voice information, a sequence of providing a response to the user; and

an information processing server configured to generate response information based on the received voice information, and transmit the response information to the client device,

wherein the information processing system being configured to enable a plurality of sequences, each being the sequence, to be executed in one connection established between the client device and the information processing server.

(2)

The information processing system according to (1), wherein

the client device and the information processing server are configured to establish a connection when a connection condition is satisfied, and

the connection condition is a sensor of the client device determining that it is a situation that requires the connection.

(3)

The information processing system according to (1) or (2), wherein

the client device and the information processing server are configured to disconnect the connection when a disconnection condition is satisfied, and

the disconnection condition is a sensor of the client device determining that it is a situation that does not require the connection.

(4)

The information processing system according to (1) or (2), wherein

a plurality of client devices, each being the client device, are made available,

the client device and the information processing server are configured to disconnect the connection when a disconnection condition is satisfied, and

the disconnection condition determines the client device that does not require the connection d by using a registration status of a user for the client device and a usage status of the client device.

(5)

The information processing system according to any one of (1) to (4), being configured to execute sequences of an identical connection for an identical user such that a processing step number in each sequence after the first sequence is smaller than a processing step number in the first sequence.

(6)

The information processing system according to any one of (1) to (5), being configured to execute authentication processing for the client device.

(7)

The information processing system according to any one of (1) to (6), being configured to execute user authentication processing for the user.

(8)

The information processing system according to (7), being configured not to execute the user authentication processing for an already authenticated user in the connection.

(9)

The information processing system according to any one of (1) to (8), wherein a plurality of client devices, each being the client device, are made available, and the information processing system is configured not to execute, when the client device that has received a voice input does not establish a connection with the information processing server, and when there is another client device with which a connection is established, the sequenced using a connection established with the other client device.

(10)

A client device, being configured to transmit, based on a voice of a user input from a voice input unit, voice information to an information processing server, execute, based on response information received in response to the voice information, a sequence of providing a response for the user, and enable a plurality of sequences, each being the sequence, to be executed in one connection established with the information processing server.

(11)

An information processing method including: transmitting, based on a voice of a user input from a voice input unit, voice information to an information processing server, executing, based on response information received in response to the voice information, a sequence of providing a response for the user, and enabling a plurality of sequences, each being the sequence, to be executed in one connection established with the information processing server.

(12)

An information processing program, being configured to transmit, based on a voice of a user input from a voice input unit, voice information to an information processing server, execute, based on response information received in response to the voice information, a sequence of providing a response for the user, and enable a plurality of sequences, each being the sequence, to be executed in one connection established with the information processing server.

### REFERENCE SIGNS LIST

1 (1a) Smart speaker
1b Smart TV set
2 Access point
3 Router
4 Access point
5 Information processing server
11 Control unit
12 Microphone
13 Speaker
14 Display unit
15 Operation unit
16 Camera
17 Communication unit

1. An information processing system comprising:
a client device configured to transmit, based on a voice of a user, the voice being input from a voice input unit, voice information to an information processing server, execute, based on response information received in response to the voice information, a sequence of providing a response to the user; and
an information processing server configured to generate response information based on the received voice information, and transmit the response information to the client device,
the information processing system being configured to enable a plurality of sequences, each being the sequence, to be executed in one connection established between the client device and the information processing server.

2. The information processing system according to claim 1, wherein
the client device and the information processing server are configured to establish a connection when a connection condition is satisfied, and
the connection condition is a sensor of the client device determining that it is a situation that requires the connection.

3. The information processing system according to claim 1, wherein
the client device and the information processing server are configured to disconnect the connection when a disconnection condition is satisfied, and
the disconnection condition is a sensor of the client device determining that it is a situation that does not require the connection.

4. The information processing system according to claim 1, wherein
a plurality of client devices, each being the client device, are made available, the client device and the information processing server are configured to disconnect the connection when a disconnection condition is satisfied, and
the disconnection condition determines the client device that does not require the connection by using a registration status of a user for the client device and a usage status of the client device.

5. The information processing system according to claim 1, being configured to execute sequences of an identical connection for an identical user such that a processing step number in each sequence after the first sequence is smaller than a processing step number in the first sequence.

6. The information processing system according to claim 1, being configured to execute authentication processing for the client device.

7. The information processing system according to claim 1, being configured to execute user authentication processing for the user.

8. The information processing system according to claim 7, being configured not to execute the user authentication processing for an already authenticated user in the connection.

9. The information processing system according to claim 1, wherein
a plurality of client devices, each being the client device, are made available, and the information processing system is configured not to execute, when the client device that has received a voice input does not establish a connection with the information processing server, and when there is another client device with which a connection is established, the sequence using a connection established with the other client device.

10. A client device, being configured to transmit, based on a voice of a user input from a voice input unit, voice information to an information processing server, execute, based on response information received in response to the voice information, a sequence of providing a response for the user, and
enable a plurality of sequences, each being the sequence, to be executed in one connection established with the information processing server.

11. An information processing method comprising:
transmitting, based on a voice of a user input from a voice input unit, voice information to an information processing server; executing, based on response information received in response to the voice information, a sequence of providing a response for the user; and
enabling a plurality of sequences, each being the sequence, to be executed in one connection established with the information processing server.

12. An information processing program, being configured to transmit, based on a voice of a user input from a voice input unit, voice information to an information processing server, execute, based on response information received in response to the voice information, a sequence of providing a response for the user, and enable a plurality of sequences, each being the sequence, to be executed in one connection established with the information processing server.
